(19) United States
(12) Patent Application Publication
(10) Pub. No.: US 2019/0278294 A1
(43) Pub. Date: Sep. 12, 2019

(54) AUTONOMOUS MOBILE APPARATUS, AUTONOMOUS MOVE METHOD, AND RECORDING MEDIUM

(71) Applicant: CASIO COMPUTER CO., LTD., Tokyo (JP)

(72) Inventors: Keisuke SHIMADA, Tokyo (JP); Kouichi NAKAGOME, Tokorozawa-shi (JP); Takashi YAMAYA, Tokyo (JP)

(21) Appl. No.: 16/289,154

(22) Filed: Feb. 28, 2019

(30) Foreign Application Priority Data
Mar. 7, 2018 (JP) 2018-040392
Dec. 17, 2018 (JP) 2018-235719

(51) Int. Cl. G05D 1/02; G06K 9/00; G06F 9/30

(52) U.S. Cl. CPC G05D 1/0274; G05D 1/0238; G06F 9/3004; G06K 9/00805; G05D 1/0246

(57) ABSTRACT

An autonomous mobile apparatus moves based on a predetermined map. The autonomous mobile apparatus comprise a driving unit that is configured to move the autonomous mobile apparatus, and a processor. The processor is configured to acquire presence indices that are indices indicating a possibility of presence of an object at each of different points on the map, select a point for a destination from the points based on the acquired presence indices, set the selected point as the destination, and control the driving unit to cause the autonomous mobile apparatus to move to the set destination.

### CROSS-REFERENCE TO RELATED APPLICATION

This application claims the benefit of Japanese Patent Application No. 2018-040392, filed on Mar. 7, 2018, and Japanese Patent Application No. 2018-235719, filed on Dec. 17, 2018, the entirety of the disclosures of which are incorporated by reference herein.

### FIELD

This application generally relates to an autonomous mobile apparatus, an autonomous move method, and a recording medium.

### BACKGROUND

Autonomous mobile apparatuses that autonomously move according to the purpose of use have become in wide use. For example, autonomous mobile apparatuses that autonomously move for indoor cleaning are known. Then, autonomous mobile apparatuses that have the capability of moving to the place where the user is as the destination upon recognition of a call from the user have been developed. For example, Unexamined Japanese Patent Application Kokai Publication No. 2008-46956 discloses a robot guiding system for performing positioning calculation based on signals from the sensor unit and guiding the robot to the location of the user that is obtained by the positioning calculation.

### SUMMARY

The autonomous mobile apparatus of the present disclosure is an autonomous mobile apparatus that moves based on a predetermined map, and includes a driving unit and a processor. The driving unit is configured to move the autonomous mobile apparatus. The processor is configured to acquire presence indices that are indices indicating a possibility of the presence of an object at different points on the map, select a point for a destination from the points based on the acquired presence indices, set the selected point as the destination; and control the driving unit to cause the autonomous mobile apparatus to move to the set destination.

### BRIEF DESCRIPTION OF THE DRAWINGS

A more complete understanding of this application can be obtained when the following detailed description is considered in conjunction with the following drawings, in which:

FIG. 1 is a diagram that shows the functional configuration of the autonomous mobile apparatus according to Embodiment 1 of the present disclosure;

FIG. 2 is an illustration that shows an exemplary appearance of the autonomous mobile apparatus according to Embodiment 1;

FIG. 3 is an illustration that shows an exemplary environment map according to Embodiment 1;

FIG. 4 is an illustration that shows exemplary presence indices according to Embodiment 1;

FIG. 5 is a flowchart of the call detection/move procedure according to Embodiment 1;

FIG. 6 is a flowchart of the presence index update procedure according to Embodiment 1;

FIG. 7 is a flowchart of the face location estimation procedure according to Embodiment 1;

FIG. 8 is an illustration that shows an exemplary environment map with presence indices that is used for explaining a specific case of the call detection/move procedure according to Embodiment 1;

FIG. 9 is a flowchart of the call detection/move procedure according to Embodiment 2 of the present disclosure;

FIG. 10 is a diagram that shows the functional configuration of the autonomous mobile apparatus according to Embodiment 3 of the present disclosure;

FIG. 11 is an illustration that shows exemplary index correction information according to Embodiment 3;

FIG. 12 is a diagram that shows the functional configuration of the autonomous mobile apparatus according to Embodiment 5 of the present disclosure;

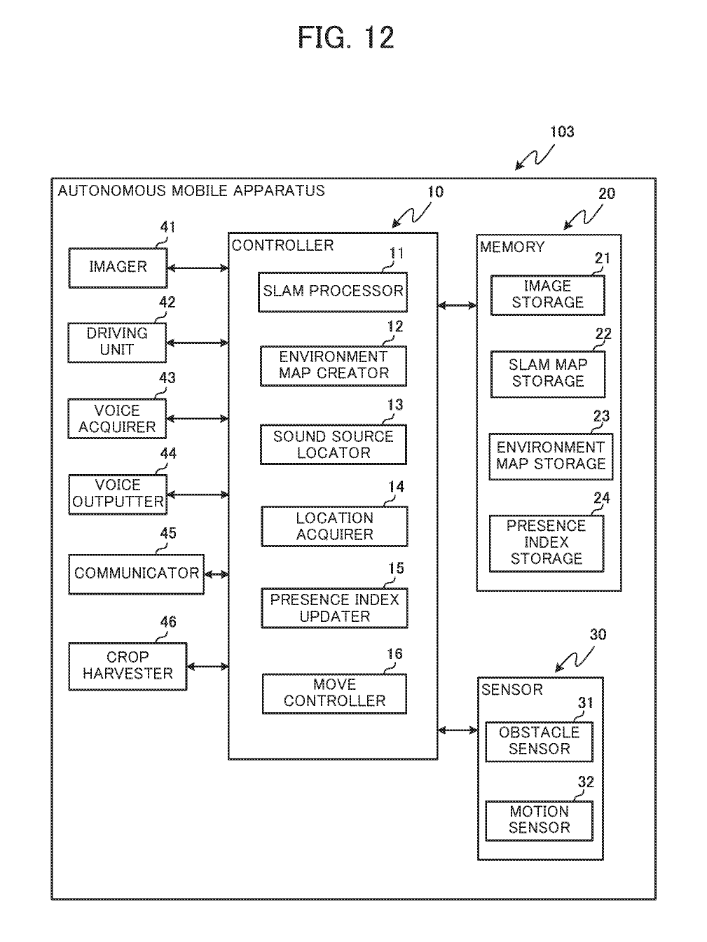

FIG. 13 is a flowchart of the crop harvesting procedure according to Embodiment 5;

FIG. 14 is a diagram that shows the functional configuration of the autonomous mobile apparatus according to Embodiment 6 of the present disclosure; and

FIG. 15 is a flowchart of the agrichemical spraying procedure according to Embodiment 6.

### DETAILED DESCRIPTION

The autonomous mobile apparatus according to embodiments of the present disclosure will be described below with reference to the drawings. Here, in the figures, the same or corresponding pails are referred to by the same reference numbers.

### Embodiment 1

The autonomous mobile apparatus according to Embodiment 1 of the present disclosure is an apparatus that autonomously moves according to the purpose of use while creating maps of the surroundings. The purpose of use includes, for example, use for security monitoring, for indoor cleaning, for pets, for toys, and the like. Then, this autonomous mobile apparatus has the capability of moving to the location where the user is present upon recognition of a call from the user.

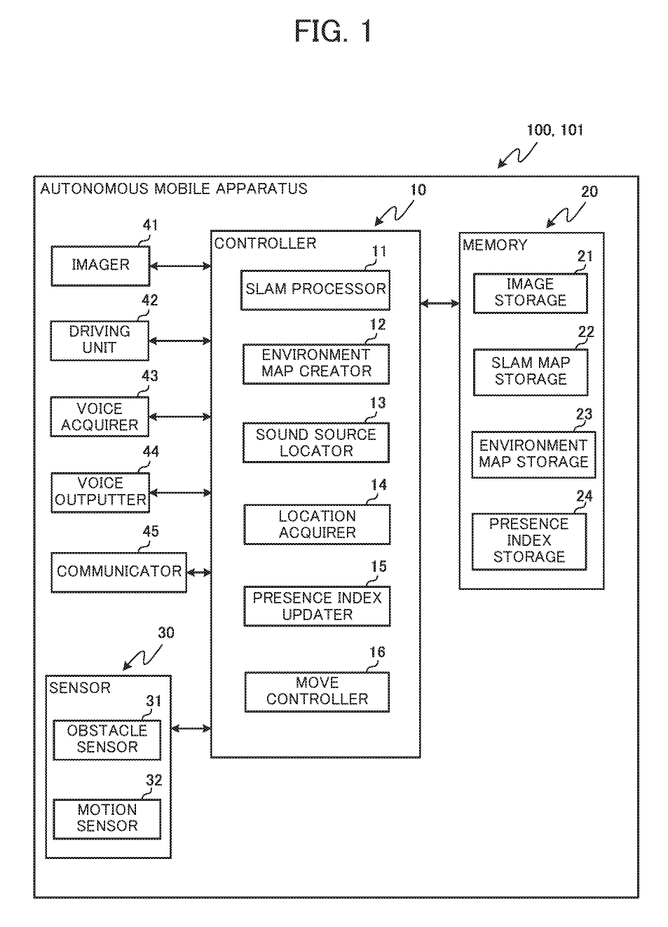

As shown in FIG. 1, an autonomous mobile apparatus 100 according to Embodiment 1 of the present disclosure functionally comprises a controller 10, a memory 20, a sensor 30, an imager 41, a driving unit 42, a voice acquirer 43, a voice outputter 44, and a communicator 45.

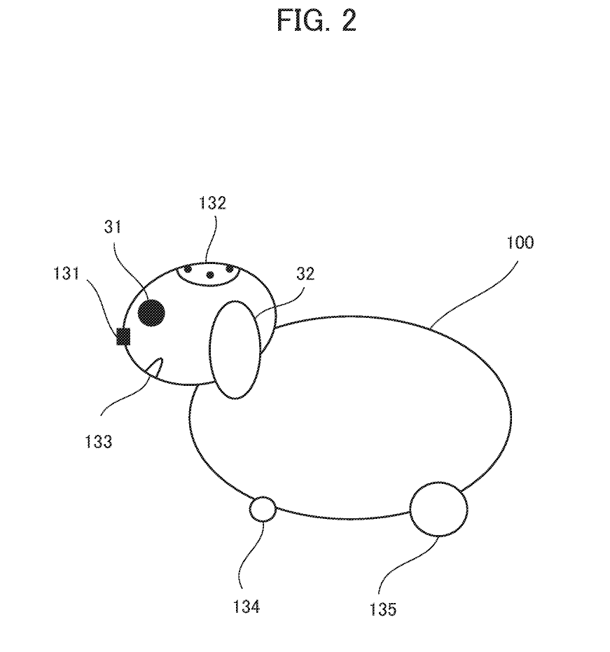

Moreover, the autonomous mobile apparatus 100 has a shape like a cute animal as shown in FIG. 2. Then, the autonomous mobile apparatus 100 comprises an obstacle sensor 31 at the position of the eye, a camera 131 at the position of the nose, a microphone array 132 that comprises multiple microphones on the head, a speaker 133 at the position of the mouth, a motion sensor 32 at the position of the ear, casters 134 at the position of the forepaw that can freely turn, and wheels 135 of an independent two-wheel drive type at the position of the hind paw.

The controller 10 comprises a central processing unit (CPU) and the like and executes programs that are stored in the memory 20 to realize the functions of the parts that are described later (a SLAM processor 11, an environment map creator 12, a sound source locator 13, a location acquirer 14, a presence index updater 15, and a move controller 16). Moreover, comprising a clock (not shown), the controller 10 can acquire the current time and measure the elapsed time.

The memory 20 comprises a read-only memory (ROM), a random access memory (RAM), and the like and functionally includes an image storage 21, a simultaneous localization and mapping (SLAM) map storage 22, an environment map storage 23, and a presence index storage 24. The ROM stores programs that are executed by the CPU of the controller 10 and data necessary preliminary to executing the programs. The RAM stores data that are created/changed while the programs are executed.

The image storage 21 stores images (frames) that are captured by the imager 41. However, for saving the storage volume, it is unnecessary to store all captured images. The autonomous mobile apparatus 100 creates data for the SLAM (data of Map points that are described later) and estimates the location of the autonomous mobile apparatus 100 by the SLAM using multiple images that are stored in the image storage 21. Images that are used in estimating the location of the autonomous mobile apparatus 100 are called key frames and the image storage 21 stores, along with information of key frame images, information of the location of the autonomous mobile apparatus 100 (the location and the orientation of the autonomous mobile apparatus 100) when those key frames are captured.

The SLAM map storage 22 stores information of feature points (that are called Map points) of which the three-dimensional locations (X, Y, Z) are obtained among feature points that are included in key frames that are stored in the image storage 21. A feature point is a point of a featuring part in an image such as an edge part or a corner part in an image. A feature point can be acquired using an algorithm such as scale-invariant feature transform (SIFT) and speeded up robust features (SURF). The SLAM map storage 22 associates and stores, as information of a feature point, its three-dimensional location and a feature quantity of the feature point (for example, a feature quantity that is obtained by the SIFT or the like).

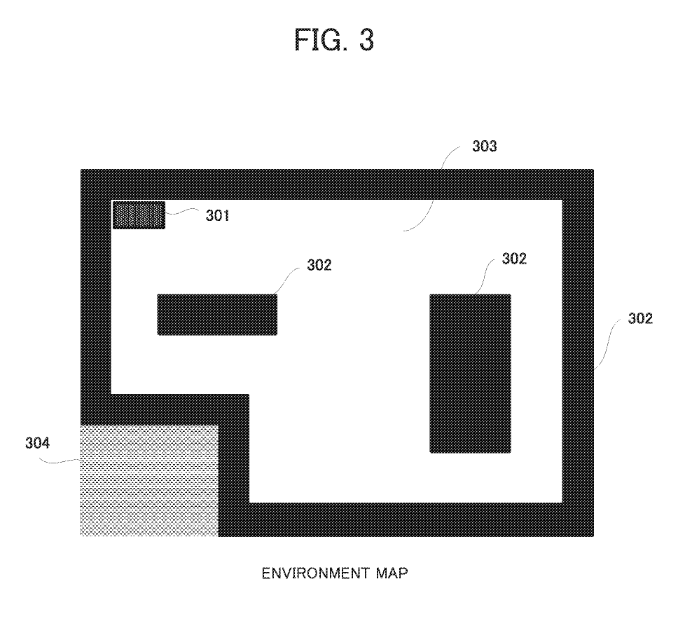

The environment map storage 23 stores an environment map that is created by the environment map creator 12 based on information from the sensor 30. An environment map is, as shown in FIG. 3, a map of a floor surface on which the autonomous mobile apparatus 100 moves and that is divided, for example, into a grid of 5 cm×5 cm squares for each of which the state of the environment (a floor surface, an obstacle, and the like) that corresponds to the square is recorded. The state of the environment includes, for example, a free space 303 where there is no obstacle and the autonomous mobile apparatus 100 can pass (move) freely, an obstacle 302 that prevents passage (movement) of the autonomous mobile apparatus 100, and an unknown space 304 of which the state is unknown. Moreover, the location of a charger 301 is recorded on the environment map.

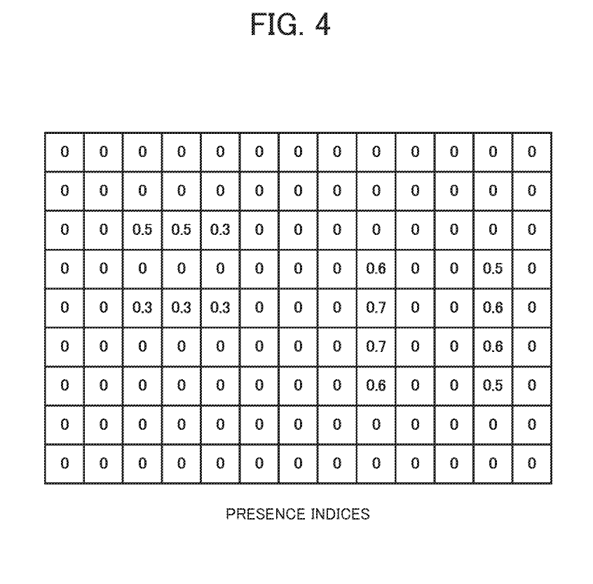

The presence index storage 24 stores indices (presence indices) that indicate the possibility of the presence of a person at different points on an environment map, which are acquired based on information from the location acquirer 14. The presence indices are such that, as shown FIG. 4, a floor surface on which the autonomous mobile apparatus 100 moves and that is divided, for example, into a grid of 5 cm×5 cm squares for each of which the probability (possibility) of the presence of a person in the square is recorded. Here, in FIG. 4, as the presence index, the probability of the presence of a person at the location of a square is recorded. However, as the presence index, the number of times of a person being detected at the location of a square may be recorded. Moreover, in FIG. 4, the probability is presented in decimal numbers. However, the probability may be expressed in integers by presenting the probability in logarithmic odds.

Moreover, FIG. 4 shows the probability of someone being present in a square without distinguishing people (the users) or without specifying a time window. However, the location acquirer 14 has the capability of identifying the user as described later; therefore, the presence index may be recorded for each user (individually). Moreover, it may be possible that the location acquirer 14 acquires the time that is a timing when the location acquirer 14 acquires a person's location from the clock that is provided to the controller 10 and the presence index in each time window is recorded. Needless to say, the presence index may be recorded for each user and in each time window.

The sensor 30 comprises an obstacle sensor 31 and a motion sensor 32. The obstacle sensor 31 is a distance sensor that can detect an object (an obstacle) that is around and measure the distance to the object (the obstacle), and for example, an infrared distance sensor or an ultrasonic sensor. Here, it may be possible to detect an obstacle using the imager 41 without installing an independent obstacle sensor 31. In such a case, the imager 41 also serves as the obstacle sensor 31. Moreover, it may be possible to comprise a bumper sensor that detects collision against another object as the obstacle sensor 31 in place of a distance sensor. In such a case, the autonomous mobile apparatus 100 can detect the presence of an obstacle at the location where the bumper sensor detects a collision.

The motion sensor 32 is a sensor that can detect the presence of a person near the autonomous mobile apparatus 100. The motion sensor 32 is, for example, an infrared motion sensor.

The imager 41 comprises a monocular imaging apparatus (the camera 131). The imager 41 captures and acquires images (frames), for example, at 30 frames per second (fps).

The autonomous mobile apparatus 100 autonomously moves while recognizing the location of the autonomous mobile apparatus 100 and the surrounding environment in real time by the SLAM based on the images that are successively acquired by the imager 41.

The driving unit 42 comprises the wheels 135 of an independent two-wheel drive type and motors and is configured to move the autonomous mobile apparatus 100 according to orders (control) from the controller 10. The autonomous mobile apparatus 100 can parallel-shift (translation) back and forth by driving the two wheels 135 in the same direction, rotate (turn) on the spot by driving the two wheels 135 in opposite directions, and circle (translation+rotation (turn)) by driving the two wheels 135 at different speeds. Moreover, each wheel 135 is provided with a rotary encoder. The amount of translation and the amount of rotation can be calculated by measuring the numbers of rotations of the wheels 135 with the rotary encoders and using geometric relationships of the diameter of the wheels 135, the distance between the wheels 135, and the like.

For example, assuming that the diameter of the wheels 135 is D and the number of rotations is C, the amount of translation at the ground contact parts of the wheels 135 is π·D·C. Here, the number of rotations, C, can be measured by the rotary encoders that are provided to the wheels 135. Moreover, assuming that the diameter of the wheels 135 is D, the distance between the wheels 135 is I, the number of rotations of the right wheel 135 is CR, and the number of rotations of the left wheel 135 is CL, the amount of rotation for turning (assuming that the right turn is positive) is 360°×D×(C_{L}−C_{R})/(2×I). Successively adding the amount of translation and the amount of rotation above, the driving unit 42 functions as so-called mechanical odometry and can measure the location of the autonomous mobile apparatus 100 (the location and the orientation with reference to the location and the orientation at the start of moving). Here, the rotary encoders that are provided to the wheels 135 function as the distance measurer.

Here, the driving unit 42 may comprise crawlers in place of the wheels 135 or may comprise multiple (for example, legs to move by walking with two legs. Also in such cases, the location and the orientation of the autonomous mobile apparatus 100 can be measured based on the movement of the two crawlers or the movement of the two legs as in the case of the wheels 135.

The voice acquirer 43 comprises the microphone array 132 that comprises multiple microphones and acquires voice in the surroundings. The autonomous mobile apparatus 100 can estimate the location of a person who has uttered voice by applying the multiple signal classification (MUSIC) method using voice data that are acquired by the microphone array 132 of the voice acquirer 43.

the voice outputter 44 comprises the speaker 133 and outputs voice. The autonomous mobile apparatus 100 can talk to the user by means of the voice outputter 44. Then, the autonomous mobile apparatus 100 can have a dialogue with the user by acquiring voice that is uttered by the user with the voice acquirer 43, recognizing the voice with the controller 10, and audio-outputting a reply content from the voice outputter 44.

The communicator 45 is a module for communicating with an external apparatus and a wireless module including an antenna when wireless-communicating with an external apparatus. For example, the communicator 45 is a wireless module for near field communication based on Bluetooth (registered trademark). Using the communicator 45, the autonomous mobile apparatus 100 can exchange data with an external source. For example, the autonomous mobile apparatus 100 can communicate with an external server (not shown) with the communicator 45 to execute some of the function of the controller 10 on the external server. Moreover, the autonomous mobile apparatus 100 can store on an external server or acquire from an external server some of the data to store in the memory 20.

Next, the functional configuration of the controller 10 of the autonomous mobile apparatus 100 will be described. The controller 10 realizes the functions of the SLAM processor 11, the environment map creator 12, the sound source locator 13, the location acquirer 14, the presence index updater 15, and the move controller 16 to control the move of the autonomous mobile apparatus 100 and so on. Moreover, the controller 10 has the capability of multithreading and can execute multiple threads (different process flows) in parallel.

The SLAM processor 11 estimates the posture (the location and the orientation) of the autonomous mobile apparatus 100 by the SLAM using multiple images that are captured by the imager 41 and stored in the image storage 21 based on information of feature points that are obtained from those images. In brief, the SLAM processor 11 estimates the location of the autonomous mobile apparatus 100 by acquiring correspondence of the same feature points between multiple key frames that are stored in the image storage 21 and acquiring the three-dimensional locations of the acquired corresponding feature points from the SLAM map storage 22. In performing this SIAM, the SLAM processor 11 extracts a feature point that is included in the image and stores, for the feature point of which the three-dimensional location is successfully calculated (a. Map point), information of the Map point in the SLAM map storage 22. Here, it may be possible to use information of mechanical odometry that can be obtained from the driving unit 42 in estimating the posture (the location and the Orientation) of the autonomous mobile apparatus 100. The autonomous mobile apparatus 100 does not need to perform the SLAM when using information of mechanical odometry in estimating the location and the orientation of the autonomous mobile apparatus 100.

The environment map creator 12 creates an environment map on which the location of the obstacle 302 is recorded using information of the location and the orientation of the autonomous mobile apparatus 100 that are estimated by the SLAM processor 11 and information from the obstacle sensor 31, and writes information of the created environment map in the environment map storage 23.

The sound source locator 13 observes voice that is uttered by the user by means of the microphone array 132 that is provided to the voice acquirer 43 and calculates the location of the origin of the voice by the MUSIC method. Here, although the microphone array 132 can observe sound other than human voice, the sound source locator 13 determines whether it is human voice using frequency components and the like of the voice that is observed by the microphone array 132. Then, the sound source locator 13 calculates where the voice is uttered (the direction in which the voice comes from and the distance to the sound source) by applying the MUSIC method to the human voice (sound). Moreover, performing user identification using frequency components and the like of the observed voice, the sound source locator 13 can identify who's voice that voice is and acquire by whom and where the voice is uttered.

The location acquirer 14 detects a human face in the image that is acquired by the imager 41 to acquire the location where a person is present. The location acquirer 14 estimates the distance to the location where the person is present based on the size of the face in the image and estimates the direction in which the person is present from the imaging direction of the imager 41 and the position of the human face in the image. The location acquirer 14 acquires the location where the person is present from these estimation results. Moreover, the location acquirer 14 can also acquire who is at what location through user identification on the detected face. Here, where the user identification is unnecessary, the location acquirer 14 may acquire the location of a person using the motion sensor 32.

The presence index updater 15 acquires the presence probability of a person at each of multiple points on the environment map that is stored in the environment map storage 23 using information of the location of a person that is acquired by the location acquirer 14, and updates the present index that is stored in the presence index storage 24 using the acquired presence probability.

Receiving a destination order from an upper-layer application program that is described later, the move controller 16 sets a route and a moving speed and controls the driving unit 42 to move the autonomous mobile apparatus 100 along the set route. For setting a route, the move controller 16 sets a route from the current location of the autonomous mobile apparatus 100 to a destination based on the environment map that is created by the environment map creator 12.

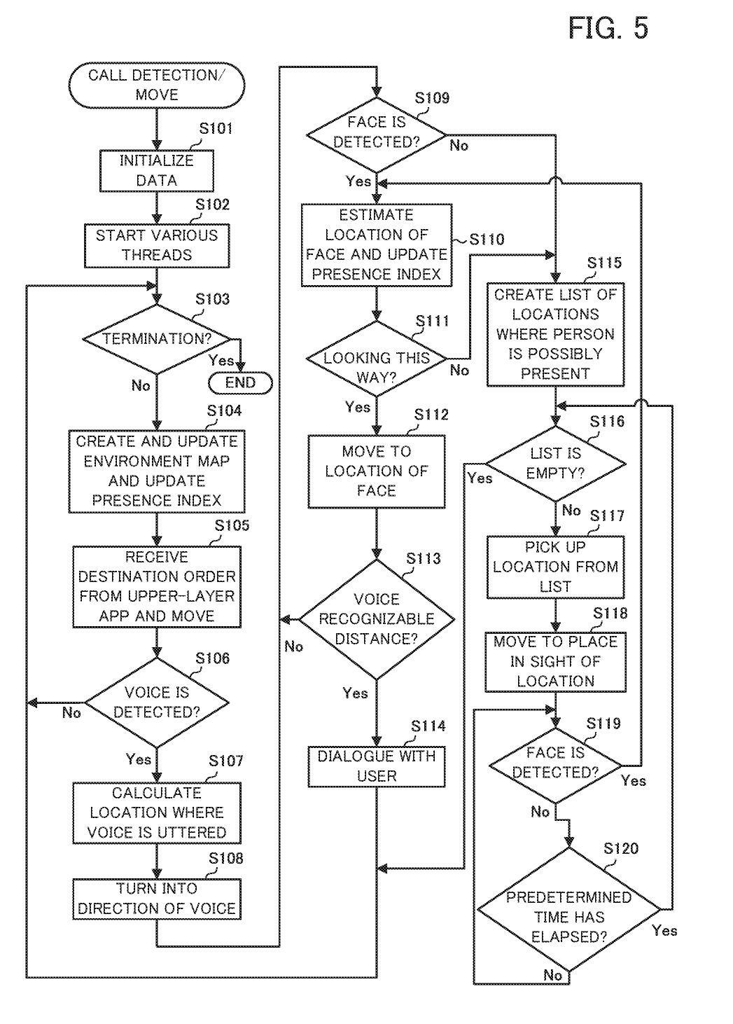

The functional configuration of the autonomous mobile apparatus 100 is described above. Next, the call detection/move procedure of the autonomous mobile apparatus 100 will be described with reference to FIG. 5. The autonomous mobile apparatus 100 is connected to the charger 301 (a charge station) while powered off. Upon power-on, the call detection/move procedure starts at the location where the autonomous mobile apparatus 100 is connected to the charger 301. Here, as the autonomous mobile apparatus 100 is powered on, other than this “call detection/move” procedure, an upper-layer application program according to the purpose of use starts separately (in another thread) and the upper-layer application or the user sets a destination. For example, when the purpose of use is indoor cleaning, the upper-layer application program successively sets a place to move to as a destination for cleaning while moving around throughout an indoor space. Details of the upper-layer application program are omitted.

As the “call detection/move” procedure starts, the controller 10 of the autonomous mobile apparatus 100 initializes various data (the image storage 21, the SLAM map storage 22, the environment map storage 23, and the presence index storage 24) that are stored in the memory 20 (Step S101). As for the initialization of the environment map, the autonomous mobile apparatus 100 starts moving from the location of the charger 301 and therefore, at this point, the environment map is initialized with information that indicates that “the autonomous mobile apparatus 100 is present at the location of the charger.” Moreover, the presence index may be initialized with information that is collected in the past.

Next, the controller 10 starts various threads for the SLAM (Step S102). Specifically, the controller 10 starts an apparatus location estimation thread, a map creation thread, and a loop closing thread. With these threads in parallel operation, the SLAM processor 11 extracts feature points from an image that is captured by the imager 41 to estimate the location of the autonomous mobile apparatus 100. Explanation of the threads for the SLAM is omitted.

Next, the controller 10 determines whether it is operation termination (for example, an operation termination order is received from the upper-layer application program or the user) (Step S103). If it is operation termination (an operation termination order is received) (Step S103; Yes), the “call detection/move” procedure terminates. If it is not operation termination (no operation termination order is received) (Step S103; No), the environment map creator 12 creates and updates the environment map and the presence index updater 15 updates the presence index (Step S104). The procedure to update the presence index will be described later.

Next, the move controller 16 receives a destination order from the upper-layer application program and moves the autonomous mobile apparatus 100 (Step S105). Next, the sound source locator 13 determines whether voice is detected by the voice acquirer 43 (Step S106). If no voice is detected (Step S106; No), the processing returns to the Step S103. If voice is detected (Step S106; Yes), the sound source locator 13 calculates the location where the voice is uttered (Step S107).

Then, the controller 10 turns the imager 41 into the direction in which the voice is uttered (Step S108). In this processing, only the head of the autonomous mobile apparatus 100 may be moved to turn the imager 41 into the direction of the voice or the driving unit 42 may be driven to turn the autonomous mobile apparatus 100 itself into the direction of the voice and thus turn the imager 41 into the direction of the voice.

Then, the location acquirer 14 determines whether a face is detected in the image that is captured by the imager 41 (Step S109). If no face is detected (S109; No), the processing proceeds to Step S115. If a face is detected (Step S109; Yes), the location of the face is estimated and the presence index is updated (Step S110). The method of estimating the location of the face will be described later.

Then, the location acquirer 14 determines the person of that face is looking (paying attention) this way (toward the autonomous mobile apparatus 100) (Step S111). If not looking this way (Step S111; No), the processing proceeds to Step S115.

If the person of the face that is detected by the location acquirer 14 is looking this way (Step S111; Yes), the move controller 16 moves the autonomous mobile apparatus 100 to the location of the person (Step S112). Then, the location acquirer 14 determines whether the distance to the person of the detected face is equal to or smaller than a voice recognizable distance (for example, 1.5 m) (Step S113). If the distance to the person of the detected face is not equal to or smaller than the voice recognizable distance (Step S113; No), the processing returns to the Step S109.

If the distance to the person of the detected face is equal to or smaller than the voice recognizable distance (Step S113; Yes), the controller 10 has a dialogue with the person using the voice acquirer 43 and the voice outputter 44 (Step S114). Then, the processing returns to the Step S103.

On the other hand, if no face is detected in the Step S109 (Step S109; No) and if the person of the detected face is not looking this way in the Step S111 (Step S111; No), the controller 10 creates a “list of locations where a person is possibly present (list of candidates for a point for a destination)” based on information that is stored in the presence index storage 24 (Step S115). For example, assuming that the presence indices (the probabilities of a person being present) shown in FIG. 4 are stored in the presence index storage 24 and a reference presence index value for a “location where a person is possibly present” is 0.65, two points where the presence index is higher than 0.65 in FIG. 4 are registered on the “list of locations where a person is possibly present.” The controller 10 selects a “location where a person is possibility present (point for a destination)” in the order of registration on this list. Therefore, the list may be sorted by (a) the descending order of probability, (b) the ascending order of angular shift of the direction of the imager 41 with respect to the direction of the voice (hereinafter referred to as an “imager shift angle”), (c) the ascending order of distance from the location of the autonomous mobile apparatus 100, or the like.

Moreover, it is not always necessary to use a reference presence index value in creating a “list of locations where a person is possibly present.” For example, it may be possible to register the location for which the highest presence index is stored in the presence index storage 24 on the “list of locations where a person is possibly present” or extract a predetermined number (for example, three) of presence indices that are stored in the presence index storage 24 in the order from the highest presence index and register the locations that correspond to those presence indices on the “list of locations where a person is possibly present.”

Then, the controller 10 determines whether the list of locations where a person is possibly present is empty (Step S116). If the list is empty (Step S116; Yes), the processing returns to the Step S103. If the list is not empty (Step S116; No), one of the “locations where a person is possibly present” is picked up (Step S117). Then, the driving unit 42 is controlled to move the autonomous mobile apparatus 100 to a “place in sight of the location where a person is possibly present” (Step S118). A “place in sight of the location where a person is possibly present” is a place that satisfies two conditions, (A) there is no obstacle between the “location where a person is possibly present” and the place and (B) the place is at a distance that make it possible to detect the face when there is a person at the “location where a person is possibly present.”

Here, the condition (A) can be checked based on information of the location of the obstacle 302 that is stored in the environment map storage 23. Moreover, the condition (B) can be checked by the square grid size of the environment map, the minimum face detection size, a standard face size, and the field angle of the imager 41. If multiple places satisfy the two conditions, a location that is at a shorter distance from the current location of the autonomous mobile apparatus 100 or a location where the imager shift angle is smaller is selected.

After the move, the controller 10 captures an image of the “location where a person is possibly present” with the imager 41 and determines whether a face is detected in the captured image (Step S119). If a face is detected (Step S119; Yes), the processing proceeds to the Step S110. If no face is detected (Step S119; No), it is determined whether a predetermined time (waiting time for face detection, for example, three seconds) has elapsed (Step S120). If the predetermined time has not elapsed (Step S120; No), the processing returns to the Step S119. If the predetermined time has elapsed (Step S120; Yes), the proceeding returns to the Step S116 and repeats the move to a “place in sight of the location where a person is possibility present” and the detection of a face until the “list of locations where a person is possibly present” becomes empty.

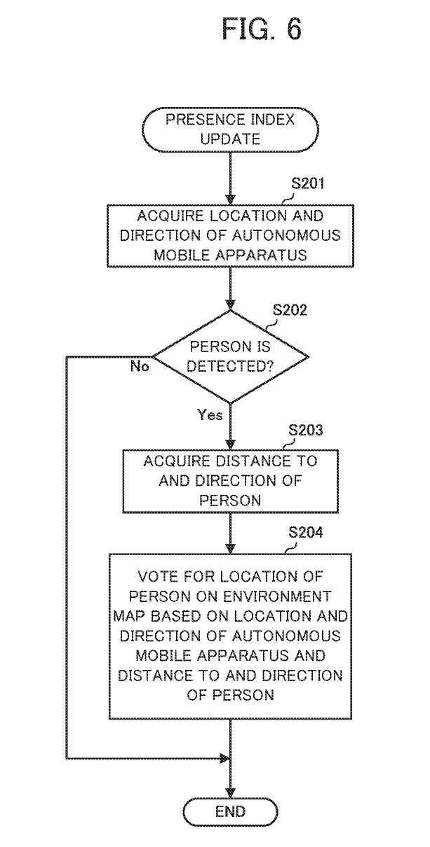

The process flow of the call detection/move procedure is described above. Next, the presence index update procedure that is performed in the above-described Step S104 will be described with reference to FIG. 6.

First, the SLAM processor 11 acquires the current location and direction of the autonomous mobile apparatus 100 by the SLAM (Step S201). Here, when already acquired in Step S301 of the face location estimation procedure that is described later, the current location and direction may be used as they are. Next, the location acquirer 14 determines whether presence of a person around the autonomous mobile apparatus 100 is detected (Step S202). If no person is detected (Step S202 No), the procedure ends.

If presence of a person around the autonomous mobile apparatus 100 is detected (Step S202; Yes), the location acquirer 14 acquires the distance to and the direction of the detected person (Step S203). For these values, when already estimated in Step S303 of the face location estimation procedure that is described later, the direction to the face and the direction of the face may also he used as they are. Then, the presence index updater 15 votes for the location of the person on the environment map based on the current location and direction of the autonomous mobile apparatus 100 that are acquired in the Step S201 and the distance to and the direction of the detected person that are acquired in the Step S203 (Step S204) and ends the procedure.

Here, voting is a type of operation for updating the presence index that is stored in the presence index storage 24 and for example, the value of the presence index (probability) that corresponds to the location of the person is incremented by a predetermined value (for example, 0.1). When expressed in the logarithmic odds, the presence index (probability) is incremented, for example, by 1.

Moreover, it may be possible to keep observing the detected person, measure the time of stay at that location, and increase the value by which the presence index is incremented as the time (the time of stay) is longer (in the case of using the logarithmic odds, for example, incrementing by m when the person stays for m minutes). Moreover, it may be possible to determine the value by which the presence index is incremented based on the likelihood that the person is detected (for example, incrementing by L when the likelihood is L).

Here, when the location acquirer 14 performs user identification through face recognition or the like, the presence index of each user and the presence index independent from the user (of all people) are each updated.

The presence index update procedure is described above. Next, the face location estimation procedure will be described with reference to FIG, 7.

First, the SLAM processor 11 acquires the current location and direction of the autonomous mobile apparatus 100 by the SLAM (Step S301). Next, the location acquirer 14 acquires the coordinates and the size in the image of a face that is detected in the Step S109 of the call detection/move procedure (FIG. 5) (Step S302). Here, it is assumed that the location acquirer 14 acquires the coordinates of the center part of the face in the image, (f_x,f_y), and the size in width f-width and height f_height.

Next, the location acquirer 14 estimates the distance to and the direction of the face (Step S303). Their respective estimation methods will additionally be described below.

First, assuming that the width of the average face size when photographed from one meter away is presented by F_WIDTH_IM, the distance to the face, f_dist, can be presented by the following expression (1):

f_dist=F_WIDTH_IM/f_width (1).

Moreover, assuming that the angle that is made with the camera 131 is presented by f_dir; the field angle of the camera 131, by AOV, and the horizontal size of a captured image of the camera 131, by WIDTH, the direction of the face can be presented by the following expression (2):

f_dir=AOV/2×|f_x-WIDTH/2|(WIDTH/2) (2)

Then, the location acquirer 14 calculates the location of the face based on the current location and direction of the autonomous mobile apparatus 100 that are acquired in the Step S301 and the distance to and the direction of the detected face that are estimated in the Step S303 (Step S304) and ends the procedure.

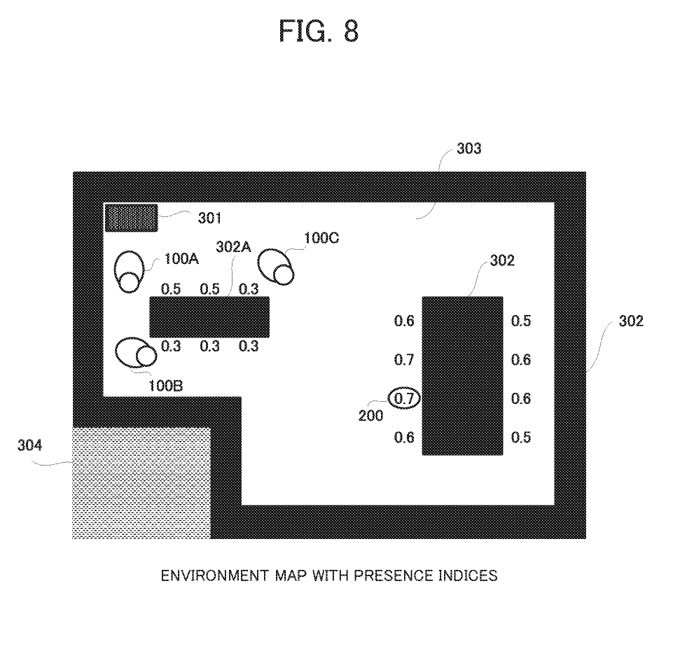

The face location estimation procedure is described above. Here, a simple specific case of the call detection/move procedure (FIG. 5) is described with reference to FIG. 8. First, it is assumed that the autonomous mobile apparatus 100 is at a location 100A in FIG. 8 and a user 200 called the autonomous mobile apparatus 100. Then,it is assumed that the autonomous mobile apparatus 100 detects voice in the direction of 45 degrees diagonally downward right in FIG. 8 (in the Steps S106 and S107). Then, even if looking in the direction of the voice (in the Step S108), the autonomous mobile apparatus 100 cannot detect the face of the user 200 (in the Step S109) because of blockage by an obstacle 302A. Therefore, the controller 10 creates a “list of locations where a person is possibly present” in the Step S115. Here, it is assumed that two locations where the presence index is 0.7 are registered on the “list of locations where a person is possibly present.”

Then, the controller 10 sorts the “list of locations where a person is possibly present” first in the descending order of probability and then in the ascending order of angular shift from the direction of the voice when seen from the location of the autonomous mobile apparatus 100. In this case, the two locations that are registered on the list have the same probability of 0.7. However, the angular shift from the direction of the voice is smaller with the lower 0.7 than with the upper 0.7 in FIG. 8. Therefore, the 0.7 where the user is present is first picked up as a “location where a person is possibly present” (in the Step S117).

Then, in the Step S118, the autonomous mobile apparatus 100 moves to a place in sight of this “location where a person is possibly present.” Here, there are two candidates 100B and 100C for the place in sight of the location where a person is possibly present. The place 100B is closer to the current location 100A. However, the place 100C has the smaller angular shift from the direction of the voice (45 degrees diagonally downward right). Thus, the autonomous mobile apparatus 100 selects the place 100E as a “place in sight of the location where a person is possibly present” when the distance is considered important and selects the place 100C when the angle is considered important and moves there. Then, the autonomous mobile apparatus 100 detects a face in the Step S119, moves to the location of the face (in the Step S112), and has a dialogue with the user (in the Step S114).

With the above processing, the autonomous mobile apparatus 100 can move to a location where a person is possibly present based on the presence index even when no human face can be found in the direction of the voice of the caller. Consequently, the possibility of being able to move to the location of the caller is increased.

Moreover, given that a presence index is stored for each user and the user is identified from voice of a caller, it is possible to create a list using the presence index of the identified user in creating a “list of locations where a person is possibly present,” thereby increasing the possibility of being able to move to the location where that user is present.

Moreover, given that a presence index is stored for each time window, it is possible to create a list using the presence index that corresponds to the time window of the current time in creating a “list of locations where a person is possibly present,” thereby increasing the possibility of being able to move to the location where a person is present.

Furthermore, given that a presence index is stored for each user and for each time window and the user is identified from voice of a caller, it is possible to create a list using the presence index of the identified user that corresponds to the time window of the current time in creating a “list of locations where a person is possibly present,” thereby increasing the possibility of being able to move to the location where that user is present.

### Modified Embodiment 1

In Embodiment 1, in creating “a list of locations where a person is possibly present (a list of candidates for a point for a destination),” a location where the presence index that is stored in the presence index storage 24 is higher than a reference presence index value (for example, 0.65) is a “location where a person is possibility present” However, it is difficult to determine whether a person is present in a region that is behind an obstacle and a blind spot from the location of the autonomous mobile apparatus 100, and thereby the value of the presence index is unlikely to rise. Then, Modified Embodiment 1 in which in creating a “list of locations where a person is possibly present,” a blind spot region is used in addition to or in place of the presence index will be described.

In Modified Embodiment 1, in creating a “list of locations where a person is possibly present” in the Step S115 of the “call detection/move” procedure (FIG. 5), the controller 10 calculates a region that is outside the imaging region of the imager 41 of the autonomous mobile apparatus 100 (a blind spot region that is a region of a blind spot from the autonomous mobile apparatus 100) from the relationship between the location of the obstacle 302 and the location of the autonomous mobile apparatus 100 on the environment map, and adds the points within the region (the blind spot region) to the “list of locations where a person is possibly present” as “locations where a person is possibly present.” Here, the controller 10 may add locations where the presence index is higher than a reference presence index value to the “list of locations where a person is possibly present” as “locations where a person is possibly present” as in Embodiment 1.

Only the difference between Modified Embodiment 1 and Embodiment 1 is described above. With the points within a blind spot region being added to the “list of locations where a person is possibly present,” if the location that is picked up in the Step S117 is within the blind spot region, a move to a place in sight of the blind spot region is made in the Step S118. Therefore, even if a person is present in a blind spot region, the controller 10 can detect his face in the Step S119.

As described above, in Modified Embodiment 1, the autonomous mobile apparatus 100 can move to a place in sight of a blind spot region where it is initially impossible to determine whether a person is present, whereby it is possible to increase the possibility of being able to move to a location where a person is present even when a person is in a blind spot region.

### Embodiment 2

Embodiment 1, the presence index is updated based on the result of a move before going to search for a person. However, the presence index may be updated based on the result of going to search for a person. Such Embodiment 2 will be described.

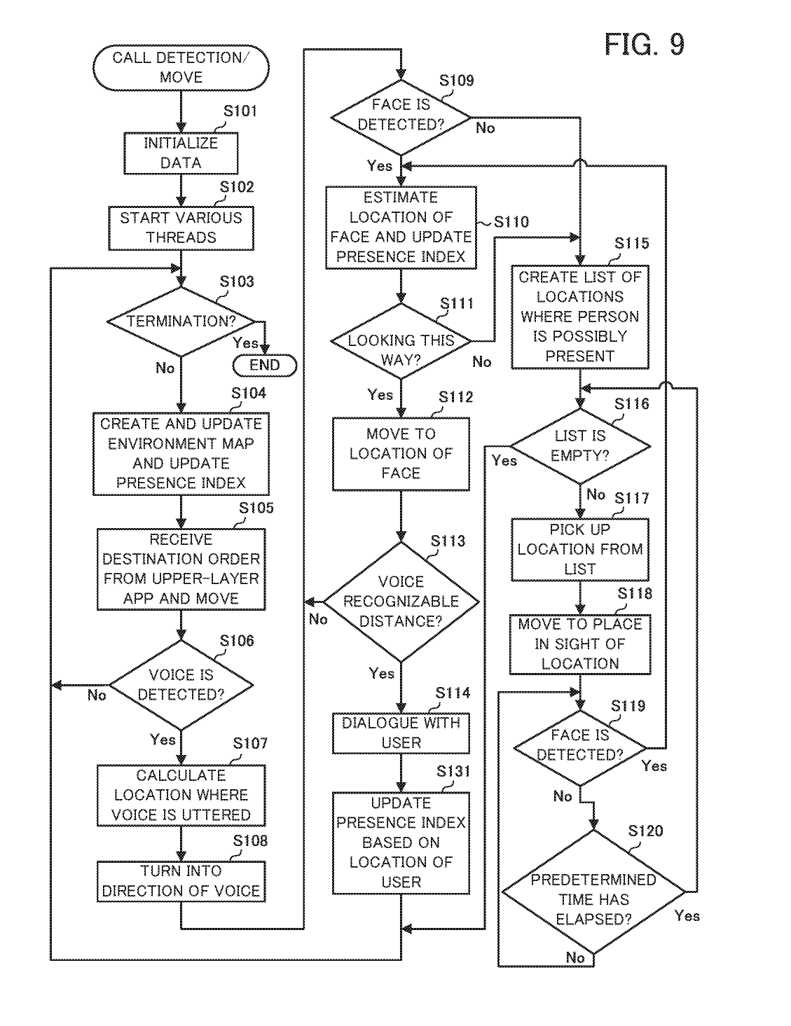

An autonomous mobile apparatus 101 according to Embodiment 2 has the same functional configuration as the autonomous mobile apparatus 100 according to Embodiment 1 shown in FIG. 1. The autonomous mobile apparatus 101 is different from the autonomous mobile apparatus 100 in the way of updating the presence index in the “call detection/move” procedure. The “call detection/move” procedure of the autonomous mobile apparatus 101 according to Embodiment 2 will be described with reference to FIG. 9.

In the “call detection/move” procedure of the autonomous mobile apparatus 101 (FIG. 9), Step S131 is added to the “call detection/move” procedure of the autonomous mobile apparatus 100 according to Embodiment 1 (FIG. 5). Therefore, the Step S131 will be described.

In the Step S131, the presence index updater 15 updates the presence index that is stored in the presence index storage 24 based on the location where the user who is approached in the Step S112 is present and dialogue results. The difference between the presence index update in the Step S131 and the presence index update in the Step S110 is as follows. In the presence index update in the Step S110, the value of the probability of the presence index that corresponds to the location of the user whose face is detected this time is simply increased (for example, 0.1 is added) regardless of presence/absence of dialogue.

On the other hand, in the presence index update in the Step S131, the value to add to the probability of the presence index is changed as follows based on dialogue results or user's uttered content (the following may be adopted in whole or only in part):
(a) the value to add is increased when having a dialogue with the approached used for example, 0.2 is added);
(b) the value to add is decreased when the user's uttered content was negative in content such as “I did not call you,” “You did not need to come,” and the like (for example, 0.01 is added); and
(c) in consideration of the dialogue time, the value to add is increased as the dialogue time is longer (for example, n/10 is added when the dialogue time is n minutes).

In Embodiment 2, as described above, the value to update the presence index is finely changed based on the dialogue results, whereby it is possible not only to simply increase the possibility of being able to move to a location where a person is present but also to increase the possibility of being able to move to a location where a person who is willing to have a dialogue with the autonomous mobile apparatus 101 is present.

### Embodiment 3

In Embodiment 1, the presence index storage 24 stores the probability of the presence of a person in each grid square as shown in FIG. 4. However, the presence index in consideration of behavioral characteristics or the like of the user may be used. Such Embodiment 3 will be described.

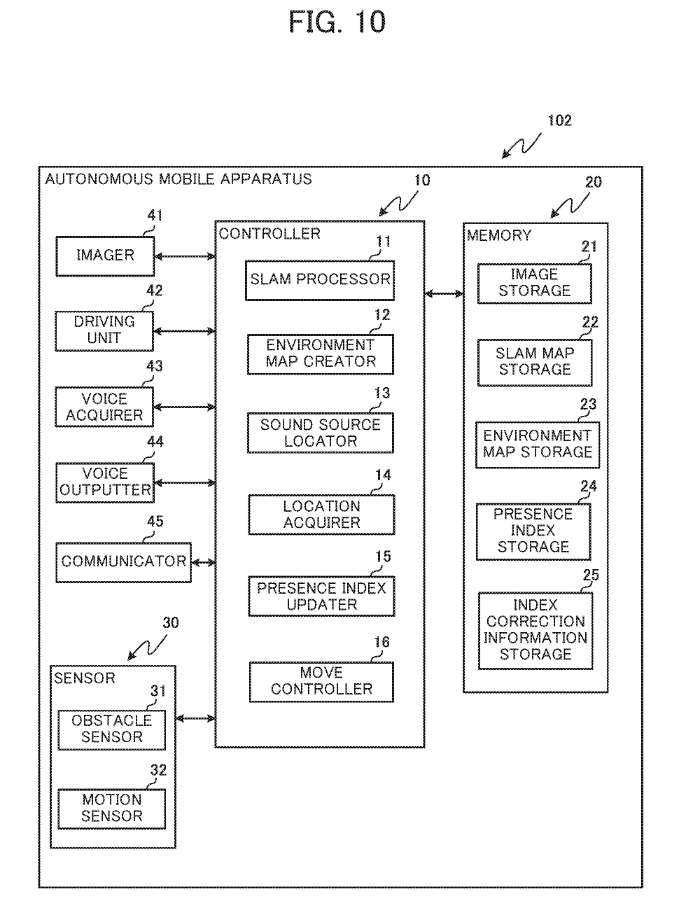

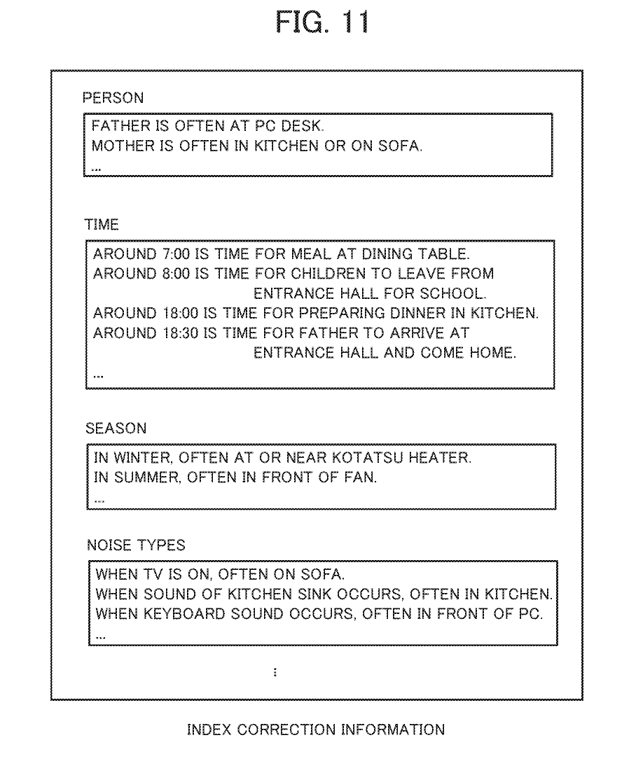

The functional configuration of an autonomous mobile apparatus 102 according to Embodiment 3 additionally comprises, as shown in FIG. 10, an index correction information storage 25 in the functional configuration of the autonomous mobile apparatus 100 according to Embodiment 1. The index correction information storage 25 stores index correction information that presents the tendency of the possibility of the presence of a person depending on a person, time, season, noise type, and the like as shown in FIG. 11. Then, the presence index of the autonomous mobile apparatus 102 is the presence index that is updated in the presence index update procedure (FIG. 6) and corrected with the index correction information shown in FIG. 11.

In the information shown in FIG. 11, any method can be used for identifying a person, identifying an object, identifying a noise, and so on. For example, voice information can be used to identify an individual through voice recognition. Moreover, image information can be used to identify an individual through face recognition, biometric recognition, or the like. Moreover, image information can be used to identify an object such as a personal computer, a sofa, or the like or identify a place such as a kitchen, an entrance hall, or the like. Moreover, sound information can be used to identify noise such as TV noise, sink noise, or the like.

In Embodiment 3, the presence index is corrected using the index correction information as described above, whereby it is possible to increase further the possibility of being able to move to the location of a user.

### Embodiment 4

In the above-described embodiments, the autonomous mobile apparatus 100, 101, or 102 that approaches the user in response to a call from the user is described. It is envisaged as Embodiment 4 that an autonomous mobile apparatus that approaches the user even if not called by the user. For example, an autonomous mobile apparatus that moves to the location of the user to wake up the user at 7:00 every morning can be envisaged. The autonomous mobile apparatus according to Embodiment 4 proceeds to the Step S115 of the call detection/move procedure (FIG. 5) and moves to a location where a person is possibly present when an approach condition (for example. 7:00 AM) is satisfied even if no voice is detected.

In such a case, it is envisaged that the user (who is in sleep) does not look toward the autonomous mobile apparatus in many cases. Therefore, in the call detection,/move procedure according to Embodiment 4, the determination in the Step S111 is skipped and the processing proceeds to the Step S112 after the Step S110. Moreover, in such a case, it is unnecessary to recognize voice of the user, and it is necessary to wake up the user even if the distance to the user is large. Therefore, the determination in the Step S113 is also skipped and a speech to wake up the user is uttered in the Step S114.

As described above, the autonomous mobile apparatus according to Embodiment 4 can move to the location of the user based on the presence index and have a dialogue with the user (utter a speech to the user) even if there is no call from the user (the current location of the user is unknown).

Moreover, as a modified embodiment of Embodiment 4, an autonomous mobile apparatus can be envisaged that moves based on the presence index that is prestored in the presence index storage 24 without detecting a person or updating the presence index. In such a case, the autonomous mobile apparatus sets as a destination and moves to a location where a person is possibly present based on the presence indices that are stored in the presence index storage 24 among multiple points on the environment map. Here, the presence indices that are prestored in the presence index storage 24 may be those that are created based on past statistics information or the like or those that are acquired from an external server via the communicator 45.

### Embodiment 5

Moreover, in the above-described embodiments, the location acquirer 14 acquires the location of a person by detecting a human face in an image that is acquired by the imager 41. However, the location acquirer 14 may acquire the location of not only a person but also an object by recognizing an object such as another robot, a substance (aluminum or iron of empty cans, plastics of containers and straw, hazardous substances, and the like), an animal (pests, destructive animals, birds/animals as food, and the like), a plant (weeds, crops, and the like) in an image that is acquired by the imager 41. Then, the presence index updater 15 can acquire the presence index (the present probability) that indicates the possibility of presence of an object at each of multiple points on the environment map that is stored in the environment map storage 23 using information of the location of the object such as a robot, a substance, an animal, or a plant that is acquired by the location acquirer 14, and update the presence index that is stored in the presence index storage 24 using the acquired presence index. Like the presence index of people, this presence index can also be obtained without distinguishing objects or individuals or may be obtained for each object or each person by identifying each object or person.

The above autonomous mobile apparatus can create a “list of locations where an object such as a robot, a substance, an animal, or a plant is possibly present” in a similar manner to the “list of the location where a person is possibly present.” Then, it is possible to increase the possibility of being able to move to a location where not only a person but also an object such as a robot, a substance, an animal, or a plant is present by moving based on this list.

Here, an autonomous mobile apparatus 103 as a crop harvesting robot is described as Embodiment 5. The functional configuration of the autonomous mobile apparatus 103 according to Embodiment 5 is, as shown in FIG, 12, the same as the functional configuration of the autonomous mobile apparatus 100 (FIG. 1) except that a crop harvester 46 is provided. However, the autonomous mobile apparatus 103 does not need to comprise the voice acquirer 43 and the sound source locator 13 and the motion sensor 32 if it is unnecessary to respond to a call from a person or to approach a person.

The crop harvester 46 harvests crops based on an order from the controller 10. Moreover, the location acquirer 14 acquires not only a location of a person but also a location where a crop is present by detecting the crop in an image that is acquired by the imager 41. Moreover, the location acquirer 14 may acquire a location of a crop of each type through image recognition on the crop type.

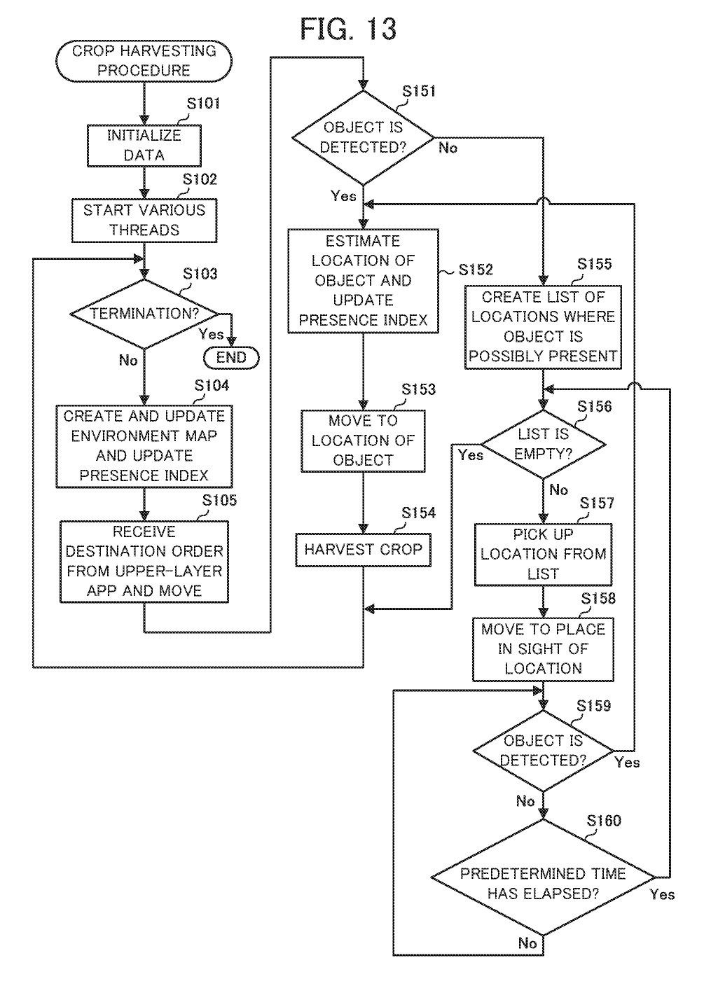

Moreover, the autonomous mobile apparatus 103 performs the crop harvesting procedure as shown in FIG. 13 in place of the call detection/move procedure (FIG. 5). As the autonomous mobile apparatus 103 is powered on, this crop harvesting procedure starts. Here, as the autonomous mobile apparatus 103 is powered on, other than this crop harvesting procedure, an upper-layer application program according to the purpose of use starts separately (in another thread) and the upper-layer application program or the user sets a destination. For example, if the purpose of use is harvesting a crop from the entire field, the upper-layer application program successively sets a point in the field as a place to move to for harvesting the crop while moving around throughout the field. Details of the upper-layer application program are omitted. Then, the crop harvesting procedure will be described with reference to FIG. 13.

The processing in the Steps S101 through S105 of the crop harvesting procedure (FIG. 13) is the same as in the call detection/move procedure (FIG. 5), and thus, its explanation is omitted. Following the Step S105, the location acquirer 14 determines whether a crop is detected in an image that is captured by the imager 41 (Step S151). If no crop is detected (Step S151; No), the processing proceeds to Step S155.

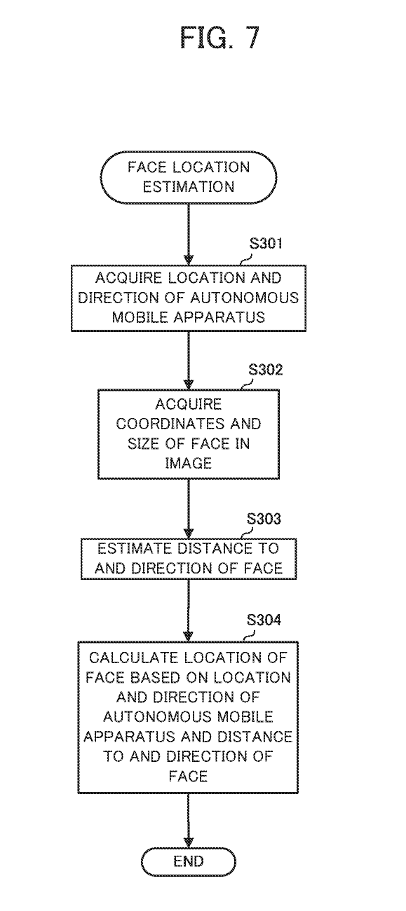

If a crop is detected (Step S151; Yes), the location of the crop is estimated and the presence index is updated (Step S152). The location of the crop can be estimated by the same method as in the above-described face location estimation procedure according to Embodiment 1 (FIG. 7). In the face location estimation procedure according to Embodiment 1 (FIG. 7), the location of a face as a target is estimated. However, in the crop location estimation in the Step S152, a crop is a target in place of a face and the location of the crop is estimated by acquiring the coordinates and the size of the crop in the image (Step S302), estimating the distance to and the direction of the crop (Step S303), anal calculating the location of the crop based on the location and the direction of the autonomous mobile apparatus 103 and the distance to and the direction of the crop (Step S304),

Moreover, the presence index can be updated by the same method as in the above-described presence index update procedure according to Embodiment 1 (FIG. 6). In the presence index update procedure according to Embodiment 1 (FIG. 6), the presence index of a person as a target is updated. However, in the presence index update in the Step S152, a crop is a target in place of a person and the presence index of the crop is updated by detecting a crop (Step S202), acquiring the distance to and the direction of the crop (Step S203), and voting for the location of the crop on the environment map based on the location and the direction of the autonomous mobile apparatus 103 and the distance to and the direction of the crop (Step S204).

Then, the move controller 16 moves the autonomous mobile apparatus 103 to the location of the crop that is estimated by the location acquirer 14 (Step S153). Then, the controller 10 controls the crop harvester 46 to perform a crop harvesting operation (Step S154) and returns to the Step S103.

On the other hand, if no crop is detected in the Step S151 (Step S151; No), the controller 10 creates a “list of locations where a crop is possibly present” based on information that is stored in the presence index storage 24 (Step S155). For example, it is assumed that the presence indices (the probabilities of the presence of a crop) shown in FIG. 4 are stored in the presence index storage 24 and the reference presence index value for a “location where a crop is possibly present” is 0.65. Two locations where the presence index is higher than 0.65 in FIG. 4 are registered on the “list of locations where a crop is possibly present.” The controller 10 selects a “location where a crop is possibly present” a point for a destination) in the order of registration on the list. Therefore, the list may be sorted (a) in the descending order of probability, (b) in the ascending order of distance from the location of the autonomous mobile apparatus 103, or the like. Here, as in the above-described Embodiment 1, in creating a “list of locations where a crop is possibly present,” it is not always necessary to use a reference presence index value and for example, it may be possible to pick up a predetermined number (for example, three) of presence indices that are stored in the presence index storage 24 from the highest and register the locations that correspond to those presence indices on the “list of locations where a crop is possibly present.”

Moreover, FIG. 4 shows the presence indices that are two-dimensional information as a result of dividing the floor into, for example, a grid of 5 cm×5 cm squares. The presence indices are not restricted to two-dimensional information. It may be possible to divide a space into, for example, a three-dimensional lattice of 5 cm in length×5 cm in width×5 cm in height and use presence indices that are three-dimensional information.

Then, the controller 10 determines whether the list of locations where an object as a crop is possibly present is empty (Step S156). If the list is empty (Step S156; Yes), the processing returns to the Step S103. If the list is not empty (Step S156; No), one of the “locations where an object is possibly present” is picked up from the list (Step S157). Then, the driving unit 42 is controlled to move the autonomous mobile apparatus 103 to a “place in sight of the location where an object is possibly present” (Step S158). A “place in sight of the location where an object is possibly present” is a place from which to the “location where an object is possibly present” there is no obstacle.

Then, the location acquirer 14 determines whether an object (a crop) is detected in an image that is captured by the imager 41 (Step S159). If an object is detected (Step S159; Yes), the processing proceeds to Step S152. If no object is detected (Step S159; No), it is determined whether a predetermined time (waiting time for object detection, for example, three seconds) has elapsed (Step S160). If the predetermined time has not elapsed (Step S160; No), the processing returns to the Step S159. If the predetermined time has elapsed (Step S160; Yes), the processing returns to the Step S156 and repeats the move to a “place in sight of the location where an object is possibly present” and the detection of an object crop) until the “list of locations where an object is possibly present” becomes empty.

With the above processing, the autonomous mobile apparatus 103 can move to a location where a crop as an object is possibly present and harvest a crop based on the presence index even when no object is detected,

Here, when another robot, not a crop, as an object is a target, in the above-described Step S159, instead of simply determining whether an object is detected, it may be possible to determine whether the face of another robot (a part that corresponds to the face of the object) is detected as in the Step S119 of the call detection/move procedure in Embodiment 1 (FIG. 5). With such determination, it is possible to perform a procedure to move toward the other robot only when the other robot is facing this way.

Here, in the case of a crop harvesting robot for a farmer who owns multiple fields, for example a field of a crop A, a field of a crop B, and so on, it may be possible to set and update a presence index that corresponds to each of the crops such as a presence index A for harvesting the crop A, a presence index B for harvesting the crop B, and so on.

### Embodiment 6

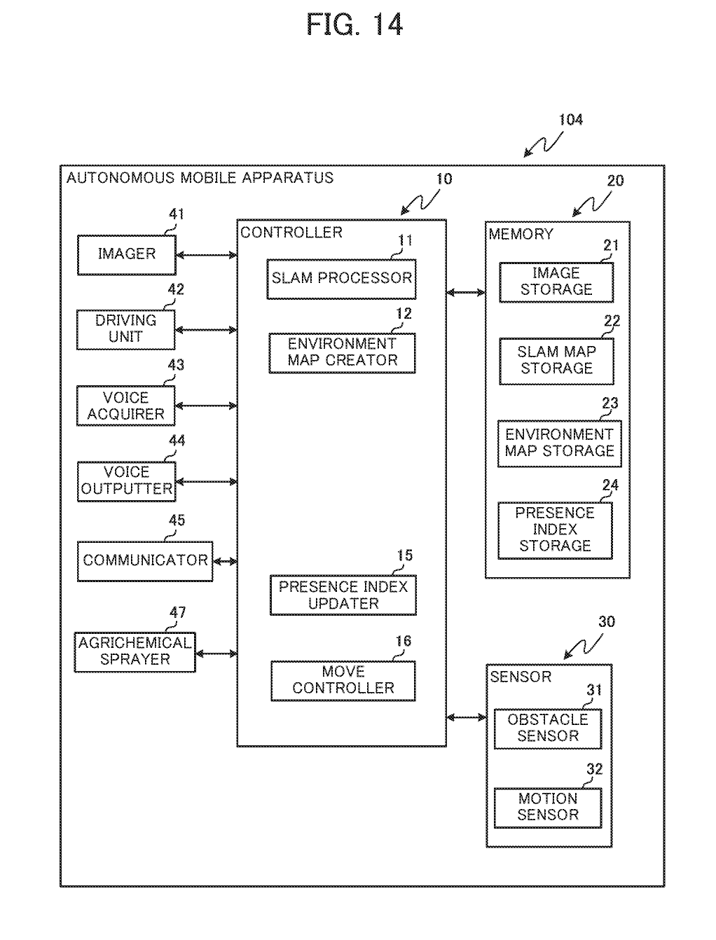

The autonomous mobile apparatus 103 according to Embodiment 5 detects a crop as an object and updates the presence index based on the location of the detected object. However, an embodiment is also envisaged in which the presence index is updated based on information from an external source without detecting an object. Here, as Embodiment 6, an autonomous mobile apparatus 104 as an agrichemical spraying robot that sprays agrichemicals without detecting pests, weeds, or crops as an object will be described. The functional configuration of the autonomous mobile apparatus 104 according to Embodiment 6 is, as shown in FIG. 14, the same as the functional configuration of the autonomous mobile apparatus 100 (FIG. 1) except that an agrichemical sprayer 47 is provided and the sound source locator 13 and the location acquirer 14 are not provided. However, like the autonomous mobile apparatus 103, the autonomous mobile apparatus 104 may also not comprise the voice acquirer 43 and/or the motion sensor 32 if it is unnecessary to respond to a call from a person or to approach a person.

The agrichemical sprayer 47 sprays agrichemicals in an amount and in a direction that are specified by the controller 10. Here, the autonomous mobile apparatus 104 does not detect an object (pests, weeds, crops). Therefore, the agrichemical sprayer 47 performs an agrichemical spraying operation at a location and in a direction based on an order that is received from the controller 10 regardless of presence/absence of an actual object.

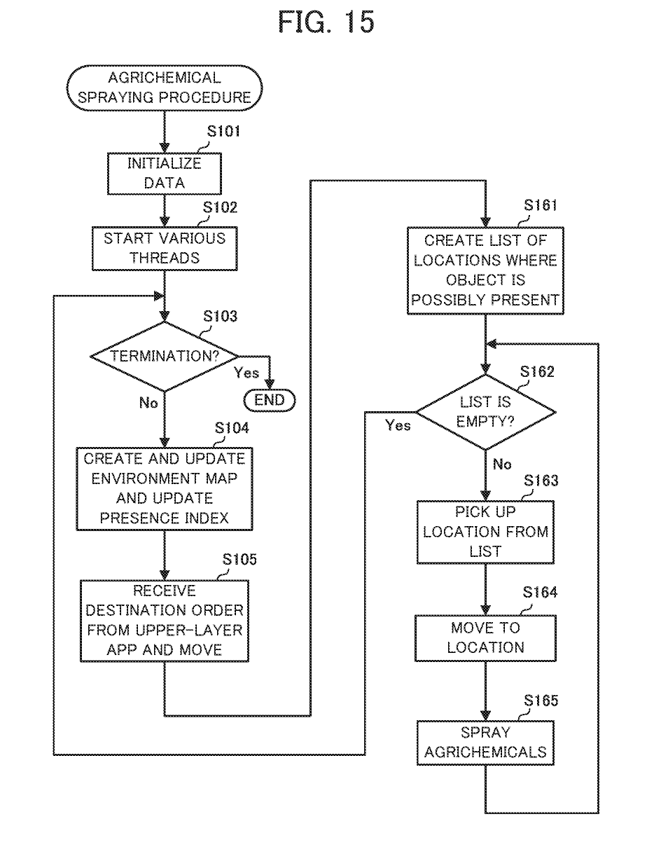

Moreover, the autonomous mobile apparatus 104 performs the agrichemical spraying procedure as shown in FIG. 15 instead of the call detection/move procedure (FIG. 5). As the autonomous mobile apparatus 104 is powered on, this agrichemical spraying procedure starts. Here, as the autonomous mobile apparatus 104 is powered on, other than this agrichemical spraying procedure, an upper-layer application program according to the purpose of use starts separately (in another thread) and the upper-layer application program or the user sets a destination. For example, if the purpose of use is spraying agrichemicals over the entire field, the upper-layer application program successively sets a point in the field as a place to move to for spraying agrichemicals while moving around throughout the field. Details of the upper-layer application program are omitted. Then, the agrichemical spraying procedure will be described with reference to FIG. 15.

The processing, in the Steps S101 through S105 of the agrichemical spraying procedure (FIG. 15) is the same as in the call detection/move procedure of Embodiment 1 (FIG. 5) and thus, its explanation is omitted. However, the autonomous mobile apparatus 104 does not detect an object (pests, weeds, crops) and therefore, the presence index update procedure that is performed in the Step S104 is different from the presence index update procedure in Embodiment 1 (FIG. 6). The presence index update procedure in the autonomous mobile apparatus 104 is a procedure to receive data of the presence index from an external source (a server, a network, a person, or the like) via the communicator 45 and write the presence index in the presence index storage 24. Places to spray agrichemicals are preliminarily known in many cases. With such places being created as presence index data on an external source (a server or the like), the autonomous mobile apparatus 104 can acquire (update) the presence index data in the Step S104.

Here, the autonomous mobile apparatus 104 does not need to perform the presence index update procedure and in this case, the presence indices that are stored in the presence index storage 24 are used as they are. The presence indices that are stored in the presence index storage 24 may be those that are created based on past statistics information or those that are acquired from an external server or the like via the communicator 45.

Then, following the Step S105, the controller 10 creates a “list of locations where an object is possibly present” based on information that is stored in the presence index storage 24 (Step S161). This processing is the same as the processing in the Step S155 of the crop harvesting procedure according to Embodiment 5 (FIG. 13). Then, the controller 10 determines whether the list of locations where an object is possibly present is empty (Step S162). If the list is empty (Step S162; Yes), the processing returns to the Step S103. If the list is not empty (Step S162; No), one of the “locations where an object is possibly present” is picked up from the list (Step S163). Then, the driving unit 42 is controlled to move the autonomous mobile apparatus 104 to the “location where an object is possibly present” (Step S164).

Then, the controller 10 controls the agrichemical sprayer 47 to perform an agrichemical spraying operation at the “location where an object is possibility present” (Step S165). Then, the processing returns to the Step S162 and repeats the move to a “location where an object is possibly present” and the spraying of agrichemicals until the “list of locations where an object is possibly present” becomes empty.

With the above-described processing, the autonomous mobile apparatus 104 according to Embodiment 6 can move to a location where an object is possibly present and spray agrichemicals based on the presence index that is acquired from an external source (or prestored) without detecting an object (pests, weeds, crops).

Also in Embodiment 6, it is possible to add the index correction information storage 25 to the memory 20 and use index correction information that is preset based not only on behavioral characteristics of people but also on characteristics of an object (pests, weeds, crops) as the index correction information (FIG. 11) that is explained in Embodiment 3. Using the index correction information, the autonomous mobile apparatus 104 can adjust the location of agrichemical spraying based on index correction information, for example, “pests often fly at the height of I m in the spring,” “pests are often on the ground in the fall,” and the like.

Moreover, Embodiment 6 can be used in the case in which a target is an object on which image recognition fails or is difficult. For example, as an autonomous mobile apparatus according to Embodiment 6, a robot can be envisaged that collects microplastics that are floating in the ocean. In such a case, an autonomous mobile apparatus in which the agrichemical sprayer 47 of the autonomous mobile apparatus 104 is replaced with a collector that collects microplastics is provided. Microplastics are fine plastics that are present particularly in the ocean. It is difficult to identify locations of microplastics through image recognition. However, it is possible to statistically calculate their presence probability in the ocean based on the locations of origins, ocean currents, and the like. Then, with the presence index being set based on the so calculated presence probability, the autonomous mobile apparatus according to Embodiment 6 can automatically move to a location where the probability of the presence of microplastics is high and efficiently collect microplastics.

Moreover, the autonomous mobile apparatus 104 according to Embodiment 6 applies to a pest control robot that exterminates pests by replacing the agrichemical sprayer 47 with a pesticide sprayer. Since pests are small and often flying around, it is often difficult to detect pests through image recognition. Moreover, even if detected, pests are soon not where they are detected in many cases (because they are flying around). However, it is possible that a person gives to the autonomous mobile apparatus 104 locations where pests are highly possibly present as presence index data or an external server transmits to the autonomous mobile apparatus 104 locations where pests are frequently present as presence index data (for example, by analyzing posted messages on a social network service (SNS) or the like). In this way, the autonomous mobile apparatus 104 can move to a location where pests are highly possibly present based on the presence index that is given from an external source and spray agrichemicals to exterminate pests.

Furthermore, also with this pest control robot, it is possible to add the index correction information storage 5 to the memory 20 and use index correction information that is preset based not only on behavioral characteristics of people but also on characteristics of pests as the index correction information (FIG. 11) that is explained in Embodiment 3. For example, trees in parks show seasonal changes. Thus, it is possible to effectively exterminate pests in parks (worms, mosquitos) by setting locations where pests highly possibly occur for each season as index correction information.

Moreover, the autonomous mobile apparatus 104 according to Embodiment 6 is also applicable to a crop harvesting robot by replacing the agrichemical sprayer 47 with the crop harvester 46. For example, for harvesting rice as a crop, places where rice should be harvested are generally preliminarily known. Therefore, in the case of a crop harvesting robot that harvests rice, if the places where rice should be harvested are prestored in the presence index storage 24, it is possible to harvest rice without acquiring the locations where rice is present through image recognition on rice. Moreover, in such a case, in the case of a crop harvesting robot for a farmer who owns multiple fields, for example a field of a crop A, a field of a crop B, and so on, it is possible to prestore on a server and receiving from the server a presence index that corresponds to each of the crops such as a presence index A for harvesting a crop A, a presence index B for harvesting a crop B, and so on, whereby the crop harvesting robot can harvest each crop using the presence index that corresponds to the crop without acquiring the location through image recognition on the crop.

### Modified Embodiment 2

The above embodiments are described on the assumption that the autonomous mobile apparatus 100, 101, 102, 103, or 104 creates a SLAM map and an environment map using the SLAM processor 11 and the environment map creator 12. However, it is not essential to create a SLAM map and an environment map. When the autonomous mobile apparatus 100, 101, 102, 103, or 104 comprises its own location estimation means such as a global positioning system (GPS) or when the moving range is within a predetermined range, it is possible to prestore in the environment map storage 23 an environment map within the moving range and thereby estimate its own location by means of the GPS without creating a SLAM map and an environment map, or move to a required place with reference to the environment map that is stored in the environment map storage 23. Such Modified Embodiment 2 is also included in the present disclosure.

Here, the functions of the autonomous mobile apparatuses 100, 101, 102, 103, and 104 can also be implemented by a computer such as a conventional personal computer (PC). Specifically, the above embodiments are described on the assumption that the program for the autonomous move control procedure that is performed by the autonomous mobile apparatuses 100, 101, 102, 103, and 104 is prestored on the ROM of the memory 20. However, the program may be saved and distributed on a non-transitory computer-readable recording medium such as a flexible disc, a compact disc read-only memory (CD-ROM), a digital versatile disc (DVD), and a magneto-optical disc (MO), and read and installed on a computer to configure a computer that can realize the above-described functions.

The preceding describes some example embodiments for explanatory purposes. Although the preceding discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An autonomous mobile apparatus that moves based on a predetermined map, the autonomous mobile apparatus comprising:
a driving unit configured to move the autonomous mobile apparatus; and
a processor configured to
acquire presence indices that are indices indicating a possibility of presence of an object at different points on the map;
select a point for a destination from the points based on the acquired presence indices;
set the selected point as the destination; and
control the driving unit to cause the autonomous mobile apparatus to move to the set destination.

2. The autonomous mobile apparatus according to claim 1, wherein the processor is configured to
determine whether the object to be designated as the destination is detected; and
execute, when a determination is made that the object is not detected, the destination setting based on the presence indices, and set, when a determination is made that the object is detected, a location of the detected object as the destination.

3. The autonomous mobile apparatus according to claim 2, further comprising:
an camera configured to capture an image of surroundings of the autonomous mobile apparatus,
wherein the processor is configured to determine whether the object to be designated as the destination is detected based on the image of surroundings of the autonomous mobile apparatus that is captured by the camera.

4. The autonomous mobile apparatus according to claim 1, further comprising:
a camera configured to capture an image of surroundings of the autonomous mobile apparatus; and
a memory,
wherein the processor is configured to
acquire the image of surroundings of the autonomous mobile apparatus that is captured by the camera and set the presence indices based on the acquired image;
store the set presence indices in the memory; and
acquire the presence indices stored in the memory.

5. The autonomous mobile apparatus according to claim 4, further comprising:
a microphone configured to acquire voice data,
wherein the processor is configured to
calculate, based on the voice data that are acquired by the microphone, a direction in which the object is present;
acquire an image in the calculated direction that is captured by the camera; and
determine, based on the acquired image, whether the object is detected.

6. The autonomous mobile apparatus according to claim 1, further comprising:
a microphone configured to acquire voice data of surroundings of the autonomous mobile apparatus;
a speaker configured to output voice; and
a memory,
wherein the processor is configured to
perform a control to have a dialogue with a person using the microphone and the speaker, the person corresponding to the object;
set the presence indices based on a result of the dialogue with the person;
store the set presence indices in the memory; and
acquire the presence indices stored in the memory.

7. The autonomous mobile apparatus according to claim 1, wherein the processor is configured to select, from among the points, a point where a possibility of presence of the object that is indicated by the corresponding presence index is higher than the possibility that is indicated by a predetermined index reference value, and set the selected point as the destination.

8. The autonomous mobile apparatus according to claim 7, wherein the processor is configured to, when the acquired presence indices include a plurality of presence indices each indicating a possibility of presence of the object that is higher than the possibility indicated by the index reference value, set as the destination a point for which the possibility that is indicated by the corresponding presence index is the highest among the points that correspond to the plurality of presence indices.

9. The autonomous mobile apparatus according to claim 7, wherein the processor is configured to, when the acquired presence indices include a plurality of presence indices each indicating a possibility of presence of the object that is higher than the possibility that is indicated by the index reference value, calculate a distance between the autonomous mobile apparatus and each of the points corresponding to the plurality of presence indices, and set as the destination a point for which the calculated distance is the smallest among the points corresponding to the plurality of presence indices.

10. The autonomous mobile apparatus according to claim 1, wherein the processor is configured to set as the destination a point corresponding to a presence index that indicates the highest possibility of presence of the object among the points.

11. The autonomous mobile apparatus according to claim 1, further comprising:
a camera configured to capture an image in a predetermined imaging direction,
wherein the processor is configured to:
create a list of candidates for the point for the destination using the points based on the acquired presence indices;
select, from the points, points that are located within a region that is outside an imaging region of the camera, and add the selected points to the list of candidates for the point for the destination; and
select the point for the destination from the list of candidates.

12. The autonomous mobile apparatus according to claim 1, further comprising:
a memory configured to store index correction information that is preset based on characteristics of the object,
wherein the processor is configured to correct the presence indices based on the index correction information stored in the memory.

13. The autonomous mobile apparatus according to claim 1, wherein the presence indices are set without the object being identified.

14. The autonomous mobile apparatus according to claim 1, wherein the presence indices are set for each object that is identified.

15. The autonomous mobile apparatus according to claim 1, wherein the presence indices that correspond to the points are indices that indicate a possibility of presence of one and the same object or a possibility of presence of a same kind of objects at each of the points.

16. The autonomous mobile apparatus according to claim 1, wherein the object is a person.

17. An autonomous move method for an autonomous mobile apparatus that moves based on a predetermined map, the autonomous move method comprising:
acquiring presence indices that are indices indicating a possibility of presence of an object at different points on the map;
selecting a point for a destination from the points based on the acquired presence indices;
setting the selected point as the destination; and
controlling a driving unit to cause the autonomous mobile apparatus to move to the set destination.

18. A non-transitory recording medium that stores a program causing a computer of an autonomous mobile apparatus that moves based on a predetermined map to execute a predetermined process, the predetermined process comprising:
acquiring presence indices that are indices indicating a possibility of presence of an object at different points on the map;
selecting a point for a destination from the points based on the acquired presence indices;
setting the selected point as the destination; and
controlling a driving unit to cause the autonomous mobile apparatus to move to the set destination.
